(19) United States
(12) Patent Application Publication
(10) Pub. No.: US 2022/0136650 A1
(43) Pub. Date: May 5, 2022

(54) IMPROVED GARMENT

(71) Applicant: GRASSELLI S.P.A., 42020 ALBINEA (REGGIO EMILIA) (IT)

(72) Inventor: GIORGIO GRASSELLI, ALBINEA (IT)

(21) Appl. No.: 17/435,499

(22) PCT Filed: Mar. 4, 2020
(86) PCT No.: PCT/IB2020/051820

§ 371 Date: Sep. 1, 2021

(30) Foreign Application Priority Data
Mar. 5, 2019 (IT) 102019000003143

(51) Int. Cl. F16P 3/14; A41D 19/00

(52) U.S. Cl. CPC F16P 3/147; A41D 19/0031

(57) ABSTRACT

Described is a garment 1 comprising an element for the transmission of a signal designed to automatically vary its impedance in response to disturbances produced in the use of the garment 1 and a device for detecting impedance variations in the transmission element 10, 11.

This invention relates to an improved garment, with particular but not exclusive reference to a garment to be worn in the workplace.

More in detail, the invention relates especially, but not exclusively, to a glove for detecting hazardous conditions for safety of the worker, especially during operations carried out on machines equipped with moving parts, such as, for example, in the case of use of skinning machines or other machines for cutting meat.

Currently, in the sector of safety systems for skinning machines there are gloves which are able to detect interference with the blade, so as to be able to stop the motor of the toothed roller which engages the product from which the skin must be removed.

A very effective type of glove for use in safety systems for skinning machines is that protected by patent EP3309440, in the name of the same Applicant as this invention.

Although this glove and the safety system in which it is used currently have the most advanced state of the art, the Applicant has found that further research on this product leads to surprising results which allow new and previously unimaginable applications even in sectors other than that of cutting meat and safety at the workplace.

The technical purpose which forms the basis of the invention is therefore to provide a garment which, as well as being able to be used with greater efficiency in the specific safety sector for operators of machines for cutting food products, can be used with great benefits in other markets.

The technical purpose is achieved by the garment made according to claim 1.

Further features and advantages of the present invention are more apparent in the non-limiting description of a preferred embodiment of the proposed garment, as illustrated in the accompanying drawings, in which:

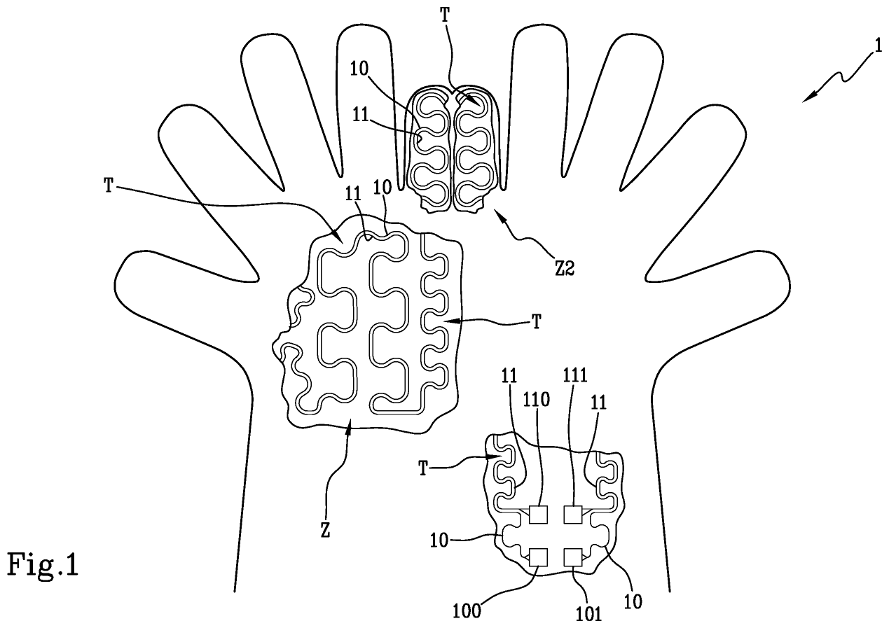

FIG. 1 shows the shape of a glove made according to the invention, in the open and flattened configuration, with zones in which the cover has been removed to show the conductive tracks;

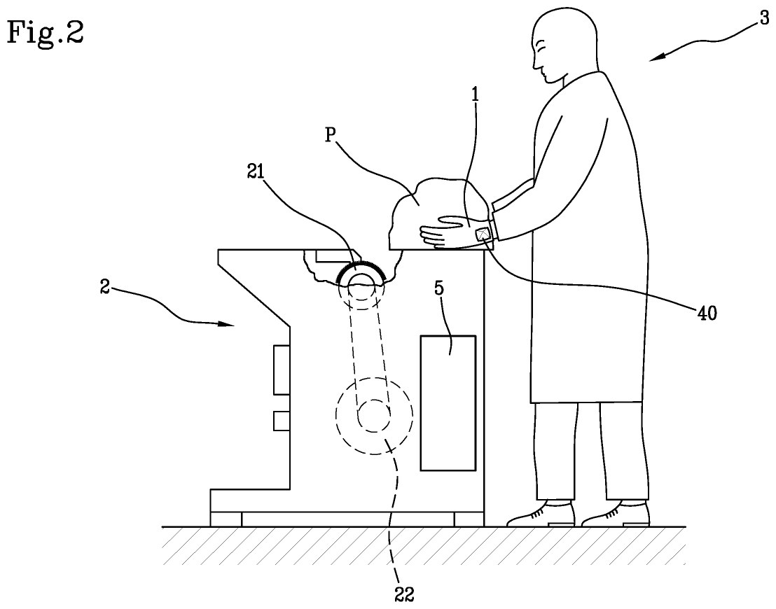

FIG. 2 is a schematic side view of an operator wearing the gloves of the previous drawing while working on a slicing machine; and

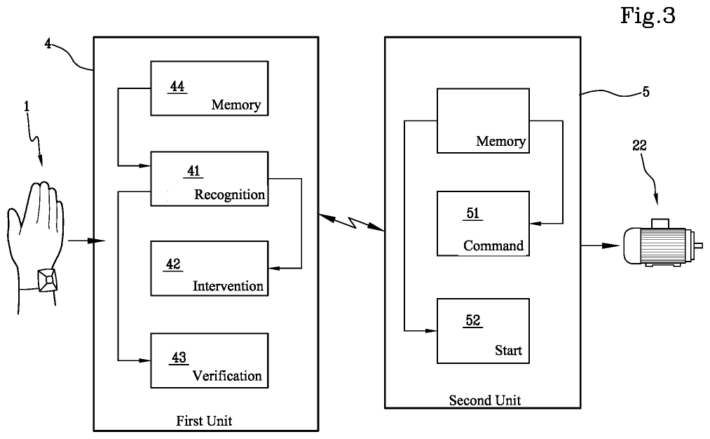

FIG. 3 is a diagram representing the first and second processing units according to the invention.

With reference to the accompanying drawings, the numeral 1 denotes a garment made according to the invention.

Although reference will be made below to the preferred embodiment wherein the garment is a glove 1, especially provided for use in the workplace, especially for the safety of the operators 3, with particular reference to the use of cutting machines for food products P, other methods for actuating the invention are not excluded in which the garment 1 is of different types and is used, for example, for games or domestic purposes.

For this reason, without limiting the scope of the invention, reference will be made below mainly to the case in which the invention relates to a glove 1 (and more specifically to a pair of gloves 1) designed to be worn by an operator 3 during use of a skinning machine 2; examples of how the invention can be used for other uses will in any case be described below.

The proposed garment (1) comprises at least one element 10, 11 for the transmission of signals designed to automatically vary its impedance in response to disturbances produced in the use of the garment 1.

Moreover, the garment 1 according to the invention also includes a device for measuring the impedance variations in the above-mentioned transmission element 10, 11.

For this reason, an important feature of the invention is that the transmission element 10, 11 has the property of varying its impedance following disturbances due to use of the glove 1 (or other garment made according to the invention), without the operator 3 having to perform other activities, such as, for example, the regulation of a hypothetical command. In other words, the impedance variation occurs automatically or autonomously by the transmission element 10, 11, but not spontaneously, because it is subject to a disturbance which is due to the way the glove 1 is used or to conditions in which it is found or in any case to events involving the glove 1 (or other garment), thereby determining a relative cause—effect ratio between the functional states of the glove 1 and the impedance variations.

If the signal is of the electrical type and the impedance consists of the resistance of the transmission element 10, 11, then the latter preferably consists of a track made of conductive material, for example silver or carbon, deposited by means of silk screen printing; it is also possible that the signal and the relative impedance are of the optical or acoustic or other type.

According to a possible embodiment of the glove 1, it comprises a first layer of synthetic fabric with controlled elasticity, covered by a layer of fixing substance which receives the conductive track 10, 11.

Although the silk screen printing of conductive material is of a per se known type, it has never been applied as in the invention which for the first time achieves surprising results with completely new methods.

It should be noted that an advantage of the use of this technology with the gloves and even more so in the specific sector in which the Applicant currently operates is that the resistance of the track 10, 11 varies with the movements performed by the hand wearing the glove 1; the consequences of this circumstance will become clear during the explanation of the operation of the invention.

The track 10, 11 made of conductive material forms a circuit between two electrodes 100, 101, 110, 111, which are also printed, which extend on the glove 1 passing through one or more fingers and at least part of the palm; preferably, each glove 1 includes two circuits 10, 11 and therefore in all four electrodes 100, 101, 110, 111, the respective tracks of which may be parallel to each other as shown in FIG. 1 and be approximately 1 mm apart.

Preferably, when the glove 1 is intended for use with a skinning machine 2, the circuit 10, 11 travels along both the upper and lower faces of the fingers (that is to say, of the zones of the glove 1 corresponding to the fingers) including the fingertips, the back and the palm of the hand, including the sides of the hand, opposite the thumb, including the outer side of the little finger.

As shown in FIG. 1, the circuit 10, 11 (or each circuit) may be formed by a succession, even continuous, of twists and turns T or convolutions between said electrodes 100, 101, 110, 111, which constitute curves along the circuit.

Preferably, the twists and turns T have convexities facing opposite sides and may have different shapes and sizes; in any case, the twist and turns T preferably have a “C” shape, a circular arc or mushroom shape, to obtain an effective distribution on the active zones of the glove 1.

It should be noted that two of the different functional states which can be detected using the glove 1 according to the invention and which are critical in the case of use with skinning machines or the like include the interruption of the circuit 10, 11 and the electrical connection between two different tracks positioned on the glove 1, since they are functional states correlated with hazardous events for the physical safety of the hand of the operator 3.

In fact, the interruption of the circuit 10, 11 may occur due to the cutting of the glove 1 by the blade of the skinning machine (or another machine) and the electrical connection between two tracks 10, 11 may occur following their simultaneous contact by the blade; these events and their management will be described in more detail below.

The parts of the glove 1 affected by the circuit 10, 11 or by the circuits may have zones Z1, Z2 with greater or lesser density of the above-mentioned twists and turns T, depending on the type of sensitivity required.

In a zone Z1 with “basic” intensity, positioned, for example, along the palm and/or the back of the hand, the density may be defined by the rule according to which each point of each twist and turn T is at the most 20 mm from at least one point of a different twist and turn T.

In a zone Z2 with increased density, for example along the fingers, each point of each twist and turn T is at the most 10 mm from at least one point of a different twist or turn T, or these points are spaced at the most at 5 mm.

The glove 1 according to the invention can be inserted in a control system, which in the case of a skinning machine 2 is in practice a safety system, which also includes a first processing unit 4 connected to the above-mentioned detection device.

The first processing unit 4 comprises a recognition module 41 which is configured to determine functional states of the glove 1 on the basis of impedance variations detected.

More in detail, as mentioned, the recognition module 41 is designed to determine the hazardous functional states corresponding both to the cutting of at least one of the tracks, and therefore the interruption of the circuit 10, 11 and to the simultaneous contact of the blade with two different tracks; in both cases, these are hazardous conditions for the safety of the operator 3 and, therefore, the skinning machine 2 is stopped, with particular reference to the immediate locking of the motor-driven roller 21, which must stop rotating in order to prevent a further pulling of the hands of the operator 3 towards the blade.

It should be noted that the processing units 4, 5 described here are presented as divided into separate functional modules for the purpose of describing the functions clearly and completely.

In practice, the processing unit 4,5 may consist of a single electronic device, suitably programmed to perform the functions described and the various modules can correspond to hardware units and/or software routines forming part of the programmed device.

Alternatively or in addition, the functions can be performed by a plurality of electronic devices on which the above-mentioned functional modules can be distributed.

The processing units 4, 5 may include a microprocessor or a microcontroller and the memory modules or other components necessary for its operation.

Preferably, according to the invention, each glove 1 is integral with the respective detecting device and the respective first processing unit 4, so as to allow total freedom of movement for the operator 3 who wears them.

In other words, the following are mounted on each glove 1, preferably protected by a cover 40: the device for measuring variations in the resistance of the conductive tracks, the first processing unit 4 and a transceiver device, preferably “wireless”, connected to the first processing unit 4, with which alarm or other signals produced by the processing unit 4 can be sent.

Both in the case of use of the gloves 1 proposed with a skinning machine 2 and for use with other machines equipped with at least one moving element, the control system according to the invention also comprises a second processing unit 5, associated with the moving element, configured for receiving signals and comprising a control module 51 configured for altering the operation of the element, following the reception of an intervention signal.

In the case of a skinning machine 2, the intervention signal must be considered as an alarm signal and the second processing unit 5 is configured to stop the motor 22 which drives the above-mentioned roller 21, after receiving the alarm signal.

Transmission means are also provided, of which the transceiver device on the glove 1 forms part, which are used to transmit signals from the first processing unit 4 to the second processing unit 5, the latter in turn comprising a wireless transceiver device of its own.

It should be noted that the alarm signal (or, more generally, the intervention signal) is generated, based on the functional state of the glove 1, by an intervention module 42, connected to the above-mentioned recognition module 41.

For this reason, if it is detected, by acquiring a characteristic variation of impedance on the conductive track or tracks 10, 11, that the glove 1 is in at least one of the above-mentioned two functional hazardous states, then an alarm signal is transmitted from the gloves 1 to the skinning machine 2 which immediately stops the relative roller 21.

Moreover, the recognition module 41 of each first processing unit 4 is preferably configured to detect the functional state corresponding to the fact that the glove 1 is worn and the functional state corresponding to the fact that the glove 1 is not worn.

In this case, the first processing unit 4 includes a checking module 43 configured to generate a check signal which is a function of the functional state corresponding to the wearing or failure to wear of the glove 1.

The second processing unit 5 comprises a start module 52 configured to allow or inhibit the starting of the roller 21 (or other movable element in the case of other machines) as a function of the checking signal received from the first processing unit 4.

More specifically, the second processing unit 5 allows starting the motor 22 of the roller 21 only if it receives the positive signals for checking the presence of the hands by both the gloves 1.

In practice, as mentioned, the conductive tracks placed on the glove 1 vary in terms of resistance when the operator 3 moves his/her hands and it is possible to calibrate the first processing unit 4 in such a way as to “recognise” this condition.

For this purpose, parameters can be loaded in a memory module 44 of the first processing unit 4 corresponding to a multiplicity of characteristic impedance variations (for example, consisting of ranges of resistance values) which correspond to respective functional states, verified by means of an experimental or self-learning step; obviously, the same applies also for detecting the contact condition of the blade with several tracks.

A possible mode of operation of the invention is briefly explained below.

If the operator 3 does not wear gloves, the relative first processing unit 4 does not send signals for checking the presence of the hands and therefore the motor 22 of the roller 21 is inhibited and therefore the skinning machine 1 cannot be used.

If the operator 3 diligently wears the gloves 1, then the machine 2 can be used.

If, during work, the operator 3 touches the blade with the glove 1, which would cause the two tracks 10, 11 to be electrically connected by the blade itself or the blade cuts the glove 1, which would cause the interruption of one or both of the circuits 10, 11 defined by the tracks, the first processing unit 4 would send alarm signals to the second unit 5 which would immediately stop the roller 21, thereby avoiding injury or greater injury to the hands of the operator 3.

As mentioned, the invention may also have uses which are very different from that of the safety of the operator working on machines for cutting meat or in general different from the field of safety at the workplace.

For example, considering that there is at least one track for each finger, therefore ten electrodes, it is possible to determine, using a suitably programmed processing unit, how the fingers move instant by instant, thereby allowing remote commands of tools or applications in virtual or augmented reality, which are included in the general concept of the invention as claimed and described.

1. A garment (1) comprising:
at least one element for the transmission of a signal designed to automatically vary its impedance in response to disturbances produced in the use of the garment (1);
at least one device for measuring impedance variations in said transmission element (10, 11).

2. The garment (1) according to claim 1, wherein the transmission element (10, 11) is electrically conductive and is designed to automatically vary its resistance as a function of said disturbances.

3. The garment (1) according to claim 2, wherein said transmission element (10, 11) is a track made using the silk screen process on conductive material.

4. The garment (1) according to claim 3, wherein the printed material is selected between carbon and silver.

5. A glove (1) made according to claim 1, wherein the transmission element (10, 11) defines a circuit (10, 11) between two electrodes which passes through one or more fingers and at least a part of the palm and/or the back of the hand.

6. The glove (1) according to claim 5, wherein said circuit (10, 11) runs along the palm, the front of all the fingers and the part of the hand opposite the thumb.

7. The glove (1) according to claim 5, wherein said circuit (10, 11) runs along the back of the hand in addition to the palm and both opposite sides of the fingers.

8. The glove (1) according to claim 5, wherein the circuit (10, 11) is made up of a succession of twists and turns (T) between said electrodes.

9. The glove (1) according to claim 8, wherein each point of each twist and turn (T) is at the most 20 mm from at least a point of a different twist and turn (T).

10. The glove (1) according to claim 9, comprising one or more zones with increased density (Z2), in which each point of each twist and turn (T) is at the most 10 mm from at least a point of a different twist and turn (T).

11. The glove (1) according to claim 10, wherein in said zone with increased density said points are spaced at no more than 5 mm.

12. The glove (1) according to claim 10, wherein each finger comprises at least a respective zone of increased density (Z2).

13. The glove (1) according to claim 5, comprising at least two circuits (10, 11) between respective pairs of electrodes (100, 101, 110, 111).

14. The glove (1) according to claim 13, wherein said circuits (10, 11) are parallel.

15. The glove (1) according to claim 14, wherein the two circuits are spaced substantially 1 mm from each other.

16. A control system which includes a garment (1) according to claim 1 and at least a processing unit (4) connected to said measuring device and comprising a recognition module (41) configured to determine functional states of the garment (1) based on impedance variations detected by the above-mentioned device.

17. The system according to claim 16, wherein the transmission element (10, 11) defines a circuit (10, 11) between two electrodes which passes through one or more fingers and at least a part of the palm and/or the back of the hand; and wherein the recognition module (41) is designed to detect a functional state corresponding to an interruption of the circuit (10, 11).

18. The system according to claim 16, wherein the transmission element (10, 11) defines a circuit (10, 11) between two electrodes which passes through one or more fingers and at least a part of the palm and/or the back of the hand; and wherein the recognition module (41) is designed to detect a functional state corresponding to the fact that the glove (1) is worn and a functional state corresponding to the fact that the glove (1) is not worn.

19. The system according to claim 16, wherein the transmission element (10, 11) defines at least two circuits (10, 11) between respective pairs of electrodes (100, 101, 110, 111); wherein said circuits (10, 11) are parallel; and wherein the recognition module (41) is designed to detect a functional state corresponding to the fact that two circuits (10, 11) are connected by an external conductor.

20. The system according to claim 16, designed to control the safety of a machine (2) equipped with a moving element (21), comprising:
a second processing unit (5) associated with the moving element, configured to receive signals and comprising a control module (51) configured for altering the operation of said element of the machine, following receipt of an intervention signal; and
transmission means for transmitting signals from the first processing unit (4) to the second processing unit (5);
wherein the first processing unit (4) comprises an intervention module (42) configured to generate an intervention signal after determination by the measuring module of at least one predetermined functional state of the glove (1).

21. The system according to claim 17, designed to control the safety of a machine (2) equipped with a moving element (21), comprising:
a second processing unit (5) associated with the moving element, configured to receive signals and comprising a control module (51) configured for altering the operation of said element of the machine, following receipt of an intervention signal; and
transmission means for transmitting signals from the first processing unit (4) to the second processing unit (5);
wherein the first processing unit (4) comprises an intervention module (42) configured to generate an intervention signal after determination by the measuring module of at least one predetermined functional state of the glove (1), wherein a first functional state corresponds to the interruption of the circuit (10, 11).

22. The system according to claim 19, designed to control the safety of a machine (2) equipped with a moving element (21), comprising:
a second processing unit (5) associated with the moving element, configured to receive signals and comprising a control module (51) configured for altering the operation of said element of the machine, following receipt of an intervention signal; and
transmission means for transmitting signals from the first processing unit (4) to the second processing unit (5);
wherein the first processing unit (4) comprises an intervention module (42) configured to generate an intervention signal after determination by the measuring module of at least one predetermined functional state of the glove (1), wherein a second functional state corresponds to the fact that the above-mentioned two circuits (10, 11) are connected by an external conductor.

23. The system according to claim 18, designed to control the safety of a machine (2) equipped with a moving element (21), comprising:
a second processing unit (5) associated with the moving element, configured to receive signals and comprising a control module (51) configured for altering the operation of said element of the machine, following receipt of an intervention signal; and
transmission means for transmitting signals from the first processing unit (4) to the second processing unit (5);
wherein the first processing unit (4) comprises an intervention module (42) configured to generate an intervention signal after determination by the measuring module of at least one predetermined functional state of the glove (1), wherein the second processing unit (5) comprises a start module (52) configured to allow or inhibit the start-up of said element (21) of the machine (2) as a function of a checking signal transmitted from the first processing unit (4), the latter comprising a checking module (43) configured to generate said checking signal on the basis of the fact that the functional state of the glove (1) detected corresponds to the wearing or not wearing by the operator 13).

24. A rind removing machine comprising a motor-driven roller (21) and a blade acting in conjunction to remove the rind of a food product (P) and a safety system according to claim 20, wherein the roller (21) is subject to said second processing unit (5) and wherein two gloves (1) are provided each equipped with a respective first processing unit (4).
